(19) United States
(12) Patent Application Publication
(10) Pub. No.: US 2018/0334272 A1
(43) Pub. Date: Nov. 22, 2018

(54) METHOD AND DEVICE FOR FILLING FLEXIBLE TUBULAR BAG PACKAGING

(71) Applicant: HILTI AKTIENGESELLSCHAFT, Schaan (LI)

(72) Inventors: Matthias WOLF, Gilching (DE); Ralf WILLNER, Tussenhausen (DE)

(73) Assignee: HILTI AKTIENGESELLSCHAFT, Schaan (LI)

(21) Appl. No.: 15/778,049

(22) PCT Filed: Dec. 13, 2016
(86) PCT No.: PCT/EP2016/080734

§ 371 Date: May 22, 2018

(30) Foreign Application Priority Data
Dec. 18, 2015 (EP) 15201023.7

(51) Int. Cl. B65B 9/12; B65B 51/30; B65B 61/06; B65B 1/04; B29C 65/08; B29C 65/00; B29C 65/74

(52) U.S. Cl. CPC B65B 9/12; B65B 51/306; B65B 61/06; B65B 1/04; B29C 65/087; B29C 66/83513; B29C 65/7451; B29C 66/1122; B29C 66/232; B29C 66/4312; B29C 66/81422; B29C 66/8491

(57) ABSTRACT

A method can fill a flexible tubular-bag packaging with a filler that contains a coarse material and can close the tubular-bag packaging. The method includes: (a) introducing a filler into a tube, (b) displacing the filler out of a closure zone of the tube, (C) pinching-off the tube in the closure zone, (d) substance-to-substance joining of oppositely disposed regions of the tube in the closure zone to form closed ends of successive tubular bags, (e) separating a tubular bag from the tube, such that two ends of successive tubular bags produced by cutting of the tube are each closed by substance-to-substance bonding.

The present invention relates to a method for filling flexible tubular-bag packaging with a filler that contains a coarse sand-like material and for closing the tubular-bag packaging. In addition, the present invention relates to an apparatus for filling flexible tubular-bag packaging with a filler that contains a coarse sand-like material and for closing the tubular-bag packaging.

The use of tubular-bag packaging is widespread in the prior art. In the associated method, a tubular film is manufactured first and then filled. After filling, the film bag is defined by pinching-off the filler in the tubular film and closing by means of a clip. Then the resulting bags are separated between the clips. One advantage of the use of tubular-bag packaging is that air-free filling of the film bags is possible. In contrast to this, only approximately air-free filling is possible with stand-up bag packaging.

Fillers containing coarse, sand-like material are, for example, chemically highly filled compounds or liquids. In this connection, the coarse, sand-like materials are usually the filler substances. In the present application, a material having one, two or more components will be understood as chemically highly filled compounds or liquids. Such compounds or liquids may be, for example, sealing compounds, multicomponent mortars, multicomponent coating compounds, multicomponent dyes, multicomponent foam precursor products, multicomponent adhesives, multicomponent sealing compounds, multicomponent lubricants and multicomponent grinding pastes. The dimensions of these filler substances may correspond partly or completely to the wall thickness of the flexible packaging.

During pinching-off of the tubular-bag packaging by means of the clip, the problem may occur that large filler particles hinder the pinching process and thus act mechanically negatively on the packaging walls. Beyond this, disturbances due to the coarse filler substances may occur during sealing of the tubular-bag packaging, which is performed via a thermal welding method or a friction welding method. This is the case when the coarse filler substances are present at the sealing places. Thereby the seal seams are leaky and do not represent a secure joint. The result is partial destruction of the seal seams. Thus the filler has a large influence on the stability of the seal seams.

A further problem in prior-art tubular-bag packaging is that film bags with various lengths and diameters may be formed due to temperature, pressure and/or rheological fluctuations of the filler being used for filling as well as of the environmental conditions. This has negative effects on the packaged geometry, especially for the subsequent mounting and handling processes.

The object of the invention is therefore, for consistent air-free filling of a flexible container, to permit leak-tight closing of the flexible container. It is intended that this will be be achieved regardless of the size of the filler particles. In addition, it is intended that a durably uniform bag length will be guaranteed despite varying temperatures, environmental conditions and filler properties.

This object is solved by the generic method that comprises the following steps:
a) introducing one or more fillers into a tube,
b) displacing the filler or fillers out of a closure zone of the tube,
c) pinching-off the tube in the closure zone,
d) substance-to-substance joining of oppositely disposed regions of the tube in the closure zone to form closed ends of successive tubular bags, and
e) separating a tubular bag from the tube, such that the two ends of successive tubular bags produced by cutting the tube are each closed by substance-to-substance bonding.

Such an inventive method makes it possible to avoid the disadvantages from the prior art.

Firstly, one or more fillers are introduced into the tube. To ensure that a pinching and closure zone as free of contamination as possible can be formed, the filler or fillers are then displaced out of the closure zone of the tube. Thereafter the tube is pinched off at that place at which a tubular bag is to be separated later from the tube. Because the filler or fillers are displaced beforehand, the danger no longer exists here that pinching will be hindered by a filler or several fillers. Because the filler or several fillers are displaced out of the closure zone beforehand, it is now possible to create a substance-to-substance joint that is free of contamination and therefore of flaws. Thus tubular bags respectively adjoining one tubular-bag beginning and one tubular-bag end are generated.

Thus the stability and quality of the tubular-bag packaging are increased.

In a preferred configuration of the inventive method, the substance-to-substance joining takes place by a welding method, especially an ultrasonic welding method. Preferably, this substance-to-substance joining takes place simultaneously with pinching-off.

Thermal welding methods and ultrasonic welding methods are able to achieve secure, substance-to-substance closing of the ends of successive tubular bags.

Stable and leak-tight sealing of the ends of successive tubular bags can be produced by both methods.

When an ultrasonic welding method is used, the input of heat into the filler and the tubular-bag packaging is reduced compared with the thermal welding method. This can be advantageous in particular for heat-sensitive fillers.

The simultaneous pinching-off and substance-to-substance joining leads to a shortened process time compared with performance of these two operating steps at successive times. Thereby the efficiency and the economy of the method can be increased.

An improvement of the method provides, beyond this, that at least four linear joint zones, especially oriented in parallel, are provided next to one another over the entire pinched-off region. Each of these linear joint zones is formed as a contiguous joint zone. The stability and leak-tightness of such a substance-to-substance joint is increased by several joint zones. Beyond this, the defect tolerance of such a joint is increased. In particular, due to the multiple construction of the joint zones, failure of the entire seal of an end of a tubular bag does not occur immediately if one joint zone fails.

The substance-to-substance, linear joint zones can be created in any desired plurality. The number of joint zones oriented in parallel is therefore consistent with the desired process safety. The more unsecure that such a joint is, the more joint zones can be created.

A parallel arrangement of linear joint zones has the consequence that a maximum number of joint zones can be disposed in the least space. Thus tubular-bag material is saved in the joint zone.

Not only linear joint zones but also broad, expansive joint zones can be created.

In addition, according to one embodiment of the invention, cutting of the tube can be performed between two linear joint zones, in order to ensure that both tubular-bag ends generated in the process, i.e. one tubular bag end and one tubular-bag beginning, are respectively closed by substance-to-substance bonding. In the process of cutting of the two successive tubular bags, the joint zones do not have to be distributed uniformly to the two successive tubular bags. For example, in the case of four joint zones in total, it is possible to undertake cutting between the first and second joint zones.

One variant of the invention provides further that pinching-off takes place in the joint zones and that, between the joint zones, regions for receiving grains of the sand-like material are created, into which grains present in the joint zone are pushed by displacement. The maximum grain size is therefore matched to the spacing of the joint zones. The regions for receiving grains situated between the joint zones receive those grains that were in the joint zone before pinching-off. Due to the displacement of the grains out of the joint zones, contamination-free joint zones are formed, which are suitable for secure, airtight, substance-to-substance joining. In this way it is ensured that the joint zones do not contain any defects that result from misdirected grains of the sand-like material.

In connection with this, one configuration of the invention provides that a rotationally driven toothed wheel is used at the side of a tube for displacement, pinching-off, substance-to-substance joining of the tube and for separation of a filled, closed tubular bag from the tube, wherein appendages oriented substantially in the direction of the axis of rotation are formed on the outside of each tooth.

Tubular bags of constant condition are created by this rotationally driven toothed wheel, regardless of the environmental conditions and regardless of the properties of the filler being used for filling. In this connection, the geometry of a toothed wheel is used in conjunction with a uniform rotational drive thereof for the inventive method. In this way a compulsory process sequence with constant times in the course of the operating steps is established. As a further result, constant lengths of the tubular bags are therefore also necessarily ensured.

In addition, the object is solved by an apparatus comprising:
a) a filling device for introducing a filler into a tube,
b) means for pinching-off the tube in a closure zone,
c) means for substance-to-substance joining of oppositely disposed regions of the tube in the closure zone, and
d) a cutting device for separating a filled, closed tubular bag from the tube in the region of the closure zone, such that the two ends of successive tubular bags produced by cutting the tube are each closed by substance-to-substance bonding.

Such a configuration of the inventive apparatus permits a sequence of the operational steps of displacement, pinching-off and substance-to-substance joining in a reliable process. In this way an apparatus is created that eliminates the disadvantages from the prior art.

In this connection, the means for pinching-off, the means for substance-to-substance joining and the cutting device may be mounted on a pneumatically or electrically driven shaft. For pinching-off, for substance-to-substance joining and for cutting or separating, the means are brought up to the tubular bag via the pneumatic, hydraulic or electrical shaft. An electronic control device ensures that these actions take place at regular time intervals and in this way constant tubular-bag lengths are guaranteed. The time intervals can be calculated from the predetermined bag length and the filling rate, which in this case is measured in volume per unit time.

Another preferred embodiment provides that a first rotationally driven toothed wheel is disposed at the side of the tube and the means for displacement, for pinching-off and for substance-to-substance joining are formed on the radial outsides of the teeth, wherein the tube is pinched between the outside of a tooth and a counter-bracing means situated on the opposite side of the tube.

Beyond this, a robust, modular construction of the inventive apparatus is achieved by the arrangement of the means for displacement, for pinching-off and for substance-to-substance joining on the toothed wheel. As an example, maintenance tasks on the inventive apparatus are facilitated in this way. By the fact that, optionally, no means for displacement, for pinching-off or for substance-to-substance joining are disposed on the counter-bracing means, this can be made as a constructively simple and thus favorable structural part.

Beyond this, the counter-bracing means may be formed by a second, rotationally mounted toothed wheel. The two toothed wheels can be driven synchronously in opposite directions of revolution, so that the tube is pinched between the outsides of oppositely disposed teeth.

In this configuration of the inventive apparatus, the rotational movements of the toothed wheels are synchronized such that the tooth tips of oppositely disposed toothed wheels always come together with one another. The tube or the tubular-bag packaging is situated between these tooth tips. The geometric properties of the toothed wheels, especially the angular offset between the means for displacement, for pinching-off and for substance-to-substance joining determine, together with the feed speed of the tube, the length of a tubular-bag packaging. Beyond this, a configuration of the counter-bracing means as a second, rotationally mounted toothed wheel avoids the situation that the tube or the tubular-bag packaging comes into sliding contact with the counter-bracing means and thus suffers damage due to this mechanical stress. Optionally, the two inventive toothed wheels may guide the tube of the tubular-bag packaging through the inventive apparatus.

Linear, radial appendages oriented substantially parallel to the axis of rotation may be provided on the outsides to form the means for pinching-off the tube. The realization of linear radial appendages on the outsides of oppositely disposed teeth is constructively simple and at the same time robust. Once the spacing between oppositely disposed toothed wheels has been set, accurately reproducible pinching-off of the tube is immediately possible with the linear, radial appendages.

The inventive apparatus may have at least four radial appendages, oriented next to one another, on one outer side, wherein the spacing of the appendages is at least 1 mm, preferably at least 2 mm.

In an advantageous variant of the invention, the appendages have sharply tapering or rounded profiles in radial sectional view through the toothed wheel. Due to this geometric configuration, it is immediately possible to displace grains of the filler to be packaged out of the joint zones. Depending on grain size, material and geometry, sharply tapering or rounded profiles may be more suitable for this purpose. A combination is likewise conceivable. Beyond this, the tubular bag is pressed together so much in the joint zones by this geometric configuration that a flawless substance-to-substance joint can be created.

In a further embodiment of the invention, the cutting device, especially in the form of a radially extendable knife, is integrated in the teeth. This configuration makes it possible to separate the filled tubular-bag ends from one another between the joint zones. Beyond this, the integration of the cutting device in the teeth of the toothed wheels permits a compact structure of the inventive apparatus. If the cutting device is configured as a radially extendable knife, this knife may be extended only at the instants at which it is needed. Thus the danger of injury for a machine operator is greatly reduced.

One improvement of the invention additionally provides that the means for substance-to-substance joining is formed by the toothed wheel and the counter-bracing means, especially wherein the first toothed wheel is formed as a sonotrode or welding jaw and the counter-bracing means is formed as an anvil or welding jaw.

The inventive apparatus further provides that the appendages form the welding contacts, whereby a more compact structure of the inventive apparatus is achieved. Accordingly, an additional element forming the welding contacts is not required.

The invention will be explained in more detail hereinafter on the basis of the attached drawings, wherein;

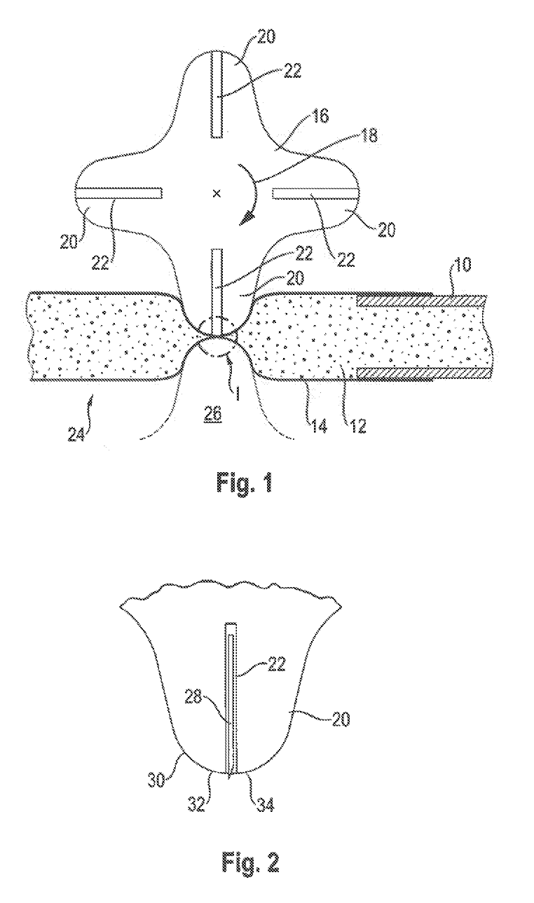

FIG. 1 shows the inventive apparatus for performing the inventive method in a schematic side view;

FIG. 2 shows an enlarged section of the apparatus according to FIG. 1;

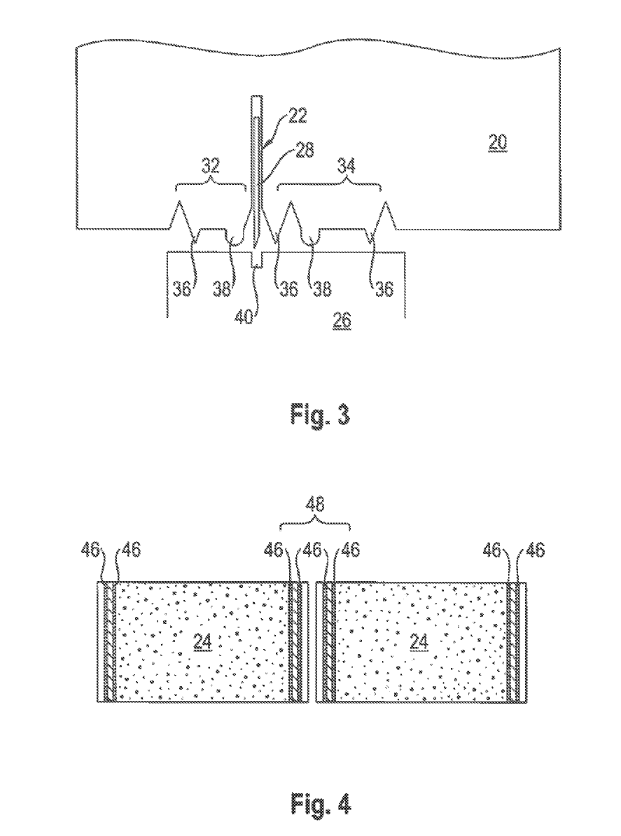

FIG. 3 shows a detail of the apparatus from FIG. 1 according to one alternative; and

FIG. 4 shows two tubular-bag packaging produced by the inventive apparatus while applying the inventive method.

FIG. 1 shows an example of an apparatus for filling and closing of tubular-bag packaging.

Via a tubular filling device, a filler 12 containing coarse, sand-like material is introduced into a flexible, film-like tube 14, which represents a tubular-bag packaging for the filler.

In general, any kind of fillers, especially one-component or multicomponent substances, especially for the construction industry, are to be understood as filler 12.

Tube 14 is traveling from right to left in FIG. 1 and is closed at its respective ends by an apparatus provided with a toothed wheel 16 rotating in the direction of the arrow, Means for pinching-off tube 14, by pinching-off tube 14 at the front and rear end, means for substance-to-substance joining of portions of tube 14 disposed opposite one another and one on top of the other, and finally cutting devices 22 for separating the filled and then closed tubular bag 24 are provided on teeth 20, which in the present case are rounded, of toothed wheel 16. The respective details will be explained more precisely hereinafter.

A so-called counter-bracing means 26, which may be constructed to be stationary and may be constructed as a rounded web oriented transverse to the transport direction of tube 14 and in axial direction of toothed wheel 16, cooperates with toothed wheel 16. Alternatively to this, it is likewise possible to construct counter-bracing means 26 as a rotating toothed wheel.

If counter-bracing means 26 is a non-rotating part, it may preferably be moved toward and away from the shaft of the toothed wheel, vertically according to FIG. 1, when tube 14 must be cycled onward.

FIG. 1 shows that the already filled tubular bag 24 is pinched off at the left of toothed wheel 16 by the tooth bearing on counter-bracing means 26. Thereby the tubular-bag packaging to be filled is simultaneously closed at the right of toothed wheel 16.

FIG. 2 shows one of the teeth 20 in detail. A cutting device 22 in the form of a radially movable knife 28, which is mounted in a corresponding slot in the tooth and which can be moved radially outward and inward by an electromechanical, hydraulic or pneumatic drive unit, is seated in each tooth 20.

Each rounded tooth 20 has several portions in the region of its tooth tip. Portions 32, 34, which form the portions of each tooth 20 pointing farthest radially outward and which pinch off tube 14 between them and counter-bracing means 26, are situated laterally next to the outlet slit for knife 28. Thus these portions 32, 34 form means for pinching-off the tube.

The region of tube 14 in which pinching-off takes place forms a so-called closure zone.

A region 30, which is not used directly for pinching-off tube 14, is situated adjoining portion 32. During rotation of toothed wheel 16, however, toothed wheel 16 displaces the grains of the material in filler 12 present in region 30 out of the later joint zones, so that no grains are situated in the joint zones. The joint zones are those oppositely disposed regions of the tubular-bag packaging that are joined to one another by substance-to-substance bonding. Thereby region 30 of tooth 20 forms a means for displacing the fillers out of the closure zones of tube 14.

In FIG. 3, the region of toothed wheel 16 and of counter-bracing means 26 shown as I in FIG. 1 is further enlarged and illustrated in an alternative variant.

Several web-like appendages oriented in axial direction of toothed wheel 16 are provided in portions 32 and 34. Of those, appendages 36 are sharply tapered and appendages 38 are rounded. These appendages 36, 38 end at counter-bracing means 26 not in a planar face but instead lead to a kind of line contact with counter-bracing means 26. While toothed gear 16 and counter-bracing means 26 are approaching one another, grains present in the closure zone are not squeezed but instead are displaced laterally, either into the intermediate spaces between appendages 36, 38 or into the bags. This rules out the possibility that grains can be situated between counter-bracing means 26 and the radial ends of appendages 36, 38. Thus contact of oppositely disposed regions of the film between appendages 36, 38 and counter-bracing means 26 is guaranteed, so that the joint zones are formed here.

The distance to be measured in transportation direction of the film between adjacent appendages 36, 38 is at least 1 mm, preferably at least 2 mm, so that sufficient space is available to receive the grains in the filler.

This variant does not necessarily also need a separate region 30 for displacement of the filler out of the joint zones. The corresponding means for displacement may also be formed by the special geometries of appendages 36, 38.

FIG. 3 additionally shows recess 40, into which knife 28 can plunge, in order to sever the film.

Toothed wheel 16, or stated more accurately appendages 36, 38, is able to act as a welding jaw or ultrasonic sonotrode, so that it has a multiple function.

The mode of operation of the apparatus will be explained hereinafter. In the embodiment illustrated in FIG. 1, toothed wheel 16 has been rotated precisely into the position illustrated in FIG. 1, so that appendages 36, 38 or, with reference to the simplified embodiment according to FIG. 2, press the regions of the shell surface disposed opposite portions 32, 34 against one another, and do so between themselves and counter-bracing means 26.

As an example, counter-bracing means 26 may be vertically positionable or disposed in stationary manner, so that tube 14 is pulled along counter-bracing means 26 during the movement of toothed wheel 16. However, when region 30 or appendages 36, 38 are moved toward counter-bracing means 26, the grains present in this region of tube 14 are displaced laterally, specifically into adjacent regions, for example between appendages 36, 38. This is followed by closing of the tube, when portions 32, 34 or appendages 36, 38 are in their final position, in which they separate tube 14 between themselves and counter-bracing means 26.

Then the welding jaw or the ultrasonic sonotrode is activated, so that the regions of tube 14 disposed on top of one another are welded to one another. As shown in FIG. 4, several parallel linear joint zones 46 are obtained, which together define closure zone 48.

In this connection, successive tubular bags 24 are closed simultaneously at their facing ends.

Then knife 28 is extended and separates the two tubular bags 24 from one another.

Preferably, as shown in FIG. 4, several joint zones, which in the illustrated exemplary embodiment are formed by appendages 36, 38 on each side, are provided alongside the cut line. Thus additional closure safety is ensured.

In the embodiment illustrated in FIG. 3, three joint zones 46 at the right of knife 28 are formed by appendages 36, 38, whereas two appendages 36, 38 and two joint zones are present at the left of knife 28.

1: A method for filling a flexible tubular-bag packaging with a filler that contains a coarse material and for closing the tubular-bag packaging, the method comprising:
(a) introducing a filler into a tube,
(b) displacing the filler out of a closure zone of the tube,
(c) pinching-off the tube in the closure zone,
(d) substance-to-substance joining of oppositely disposed regions of the tube in the closure zone to form closed ends of successive tubular bags, and
(e) separating a tubular bag from the tube, such that two ends of successive tubular bags produced by cutting of the tube are each closed by substance-to-substance bonding.

2: The method according to claim 1, wherein
the substance-to-substance joining takes place by welding.

3: The method according to claim 1, wherein
at least four linear joint zones are created next to one another over the entire closure zone.

4: The method according to claim 3, wherein
the linear joint zones are respectively formed as one contiguous joint zone.

5: The method according to claim 3, wherein
cutting of the tube is performed between two linear joint zones.

6: The method according to claim 1, wherein
said pinching-off takes place in the joint zones, and,
between the joint zones, regions for receiving grains of the coarse material are created, into which grains present in the joint zone are pushed by displacement.

7: The method according to claim 1, wherein
a rotationally driven wheel, which comprises teeth, is present at the side of the tube and carries out said displacing, pinching-off, and substance-to-substance joining of the regions of the tube,
wherein the rotationally driven wheel carries out separation of a filled, closed tubular bag from the tube, and
wherein appendages oriented substantially in the direction of the axis of rotation are formed on the outside of the teeth.

8: An apparatus for filling flexible tubular-bag packaging with a filler that contains a coarse material and for closing the tubular-bag packaging, the apparatus comprising:
(a) a filling device for introducing a filler into a tube,
(b) a device for pinching-off the tube in a closure zone,
(c) a device for substance-to-substance joining of oppositely disposed regions of the tube in the closure zone, and
(d) a cutting device for separation of a filled, closed tubular bag from the tube in the region of the closure zone, such that the ends of successive tubular-bag packaging produced by cutting the tube are each closed by substance-to-substance bonding.

9: apparatus according to claim 8, wherein
a first rotationally driven wheel, which comprises teeth, is disposed at the side of the tube,
wherein a device for displacement, and the devices for pinching-off and for substance-to-substance joining are formed on the radial outsides of the teeth, and
wherein the tube can be pinched between the outside of a tooth and a counter-bracing device situated on the opposite side of the tube.

10: The apparatus according to claim 9, wherein
the counter-bracing device is formed by a second, rotationally mounted toothed wheel and the first and second toothed wheels can be driven synchronously in opposite directions of revolution, so that the tube is pinched between outside regions of oppositely disposed teeth.

11: The apparatus according to claim 10, wherein
at least two linear, radial appendages oriented substantially parallel to the axis of rotation are provided on the outside regions to form the device for pinching-off the tube.

12: The apparatus according to claim 11, wherein
at least four radial appendages, oriented next to one another, are present on one outer side for pinching-off during a pinching-off process, and
wherein the spacing of the appendages is at least 1 mm.

13: The apparatus according to claim 11, wherein
the at least two appendages have sharply tapering or rounded profiles in radial sectional view through the first rotationally driven wheel.

14: The apparatus according to claim 9, wherein
the cutting device is integrated in the teeth.

15: The apparatus according to claim 9, wherein
the device for substance-to-substance joining is formed by the wheel and the counter-bracing device.

16: The apparatus according to claim 11, wherein
the at least two appendages form the welding contacts.

17: The method according to claim 1, wherein the substance-to-substance joining takes place by an ultrasonic welding method, and
wherein said pinching-off and said substance-to-substance joining occur simultaneously.

18: The apparatus according to claim 9, wherein
the cutting device is in the form of at least one radially extendable knife and is integrated in the teeth.

19: The apparatus according to claim 9, wherein
the device for substance-to-substance joining is formed by the wheel and the counter-bracing device, and
wherein the first wheel is formed as a sonotrode or welding jaw and the counter-bracing device is formed as an anvil or welding jaw.

20: The apparatus according to claim 11, wherein
at least four radial appendages, oriented next to one another, are present on one outer side for pinching-off during a pinching-off process, and
wherein the spacing of the appendages is at least 2 mm.
